(19) United States
(12) Patent Application Publication
(10) Pub. No.: US 2013/0337894 A1
(43) Pub. Date: Dec. 19, 2013

(54) METHODS, APPARATUSES, AND SYSTEMS FOR ON-PREMISES WAGERING FROM MOBILE DEVICES

(71) Applicant: United Tote Company, Louisville, KY (US)

(72) Inventors: Roger Villarreal, Santee, CA (US); Benjamin Murr, Louisville, KY (US); Swain Sivarajah, Sierra Madre, CA (US); Jyothi Badireddy, San Diego, CA (US); Mark Johnson, San Diego, CA (US)

(21) Appl. No.: 13/922,761

(22) Filed: Jun. 20, 2013

Related U.S. Application Data
(62) Division of application No. 13/193,271, filed on Jul. 28, 2011.

(51) Int. Cl. G07F 17/32

(52) U.S. Cl. CPC G07F 17/3244
USPC 463/25

(57) ABSTRACT

Wagering systems includes a secure wireless network operating within a wagering premises and including one or more network access points for transmitting and receiving network data for devices authorized to participate on the secure wireless network. A server system communicates with the secure wireless network and includes a server with a communication interface for conveying wager requests and wager acknowledgements on the secure wireless network and between the server and mobile devices, which send the wager requests and receive the wager acknowledgements. The mobile devices present a wager interface to enable a user to develop a wager identification including a wagering event, a wager type, and a wager amount. Responsive to the wager identification, a participant interface is presented on the mobile device for enabling the user to develop a participant identification including one or more participants for achieving one or more participant goals identified responsive to the wager type.

### CROSS-REFERENCE TO RELATED APPLICATION

This application is a divisional of U.S. patent application Ser. No. 13/193,271, filed Jul. 28, 2011, pending, the disclosure of which is hereby incorporated herein by this reference in its entirety.

### TECHNICAL FIELD

Embodiments of the present disclosure are directed to the field of pari-mutuel wagering and, more particularly, to placing pari-mutuel wagers at a wagering premises.

### BACKGROUND

Wagering on pari-mutuel horse racing can be a difficult and time-consuming activity. The wagering may involve many different types of wagers that may be placed on many different horses.

At a track, a person may elect to go to a betting window to place a wager, or to take advantage of a self-service terminal or a kiosk to place a wager. Win, Place and Show wagers are commonly referred to as “straight bets” and are easy to understand as they relate respectively to a first, second or third place finish.

With greater knowledge of the horses in a particular race, a player can attempt to predict in which order various horses will place. Additionally, players may attempt to predict not only the order of finishers in a single race, but the finishers over the span of multiple races. These wagers are known as “exotic” wagers. In an exotic wager, the player is increasing the odds for success by placing wagers on multiple horses. In addition to exotic wagers in a single race, players may also place wagers on finishers in multiple races.

The need to go to a teller or kiosk may reduce the number of players wagering on any given race, due to the inconvenience. In addition, a novice player may be intimidated by the various types of wagers and pressure to place wagers quickly when visiting a teller or placing a wager at a self-service terminal or kiosk.

The inventors have appreciated that there is a need for apparatuses and methods that use mobile devices to enable convenient ways for patrons to place wagers at a wagering facility without having to go to a teller or kiosk.

### BRIEF SUMMARY

Embodiments of the present disclosure include apparatuses, methods, and computer-readable media that use mobile devices to enable convenient ways for patrons to place wagers at a wagering facility without having to go to a teller or kiosk.

In some embodiments, a method of placing a wager includes presenting a wager interface on a mobile device to enable a user to develop a wager identification including a wagering event, a wager type, and a wager amount. A participant interface is presented on the mobile device responsive to the wager identification, the participant interface is for enabling the user to develop a participant identification including one or more participants for achieving one or more participant goals identified responsive to the wager type. A wager request including the wager identification and the participant identification is sent from the mobile device to a server via a secure wireless network configured for operation within a wagering premises and a wager acknowledgement from the server is received on the mobile device via the secure wireless network indicating acceptance of the wager request.

In some embodiments, computer-readable media include device executable instructions, which when executed by a mobile device cause the mobile device to present a wager interface on the mobile device for enabling a user to develop a wager identification including a wagering event, a wager type, and a wager amount. Responsive to the wager identification, the device executable instructions also cause the mobile device to present a participant interface on the mobile device for enabling the user to develop a participant identification including one or more participants for achieving one or more participant goals identified responsive to the wager type. The device executable instructions also cause the mobile device to send a wager request including the wager identification and the participant identification to a server via a secure wireless network configured for operation within a wagering premises and to receive from the server, via the secure wireless network, a wager acknowledgement indicating acceptance of the wager request.

In some embodiments a mobile device includes device executable instructions, which when executed by the mobile device cause the mobile device to present a wager interface on the mobile device to enable a user to develop a wager identification including a wagering event, a wager type, and a wager amount. Responsive to the wager identification, a participant interface is presented on the mobile device for enabling the user to develop a participant identification including one or more participants for achieving one or more participant goals identified responsive to the wager type. Via a secure wireless network configured for operation within a wagering premises, the mobile device sends a wager request including the wager identification and the participant identification to a server and receives a wager acknowledgement from the server indicating acceptance of the wager request.

In some embodiments, a wagering system includes a secure wireless network configured for operation within a wagering premises and including one or more network access points for transmitting and receiving network data for devices authorized to participate on the secure wireless network. The wagering system also includes a server system with one or more servers, wherein a first server is configured for communicating with the secure wireless network. The first server includes a communication interface configured for conveying wager requests and wager acknowledgements on the secure wireless network and between the first server and one or more mobile devices configured for sending the wager requests and receiving the wager acknowledgements. A memory on the first server is configured for storing server executable instructions and one or more processors are configured for executing the server executable instructions to send authorization to the one or more mobile devices to participate on the secure wireless network, receive the wager requests from the one or more mobile devices communicating over the secure wireless network, and send the wager acknowledgements to the one or more mobile devices communicating over the secure wireless network.

### BRIEF DESCRIPTION OF THE DRAWINGS

FIGS. 1A-1C are simplified block diagrams of wagering systems using a secure wireless network at a wagering premises to enable wagers to be placed from mobile devices;

FIG. 2 is a simplified flow diagram of processes performed and interfaces displayed for various activities that can be performed on a mobile device and are associated with wagering and reviewing events at a wagering premises in accordance with embodiments of the present disclosure;

FIGS. 3A and 3B are screen shots of a login interface for the mobile device that may be used in accordance with embodiments of the present disclosure;

FIG. 4 is a screen shot of a home interface for the mobile device that may be used in accordance with embodiments of the present disclosure;

FIG. 5A is a simplified flow diagram of processes performed for various activities involved with reviewing events, assembling wagers, and placing wagers, in accordance with embodiments of the present disclosure;

FIG. 5B is a screen shot of a wager interface for the mobile device that may be used for some of the processes of FIGS. 2 and 5A;

FIGS. 6A-6C are screen shots of a participant interface for the mobile device that may be used for some of the processes illustrated in FIGS. 2 and 5A;

FIG. 7 is a screen shot of a wager accepted interface for the mobile device that may be used for some of the processes illustrated in FIGS. 2 and 5A;

FIGS. 8A and 8B are screen shots of a history interface for the mobile device that may be used for some of the processes illustrated in FIG. 2;

FIGS. 9A and 9B are screen shots of an odds interface for the mobile device that may be used in accordance with embodiments of the present disclosure; and

FIG. 10 is a screen shot of a results interface for the mobile device that may be used in accordance with embodiments of the present disclosure.

### DETAILED DESCRIPTION

In the following description, reference is made to the accompanying drawings in which is shown, by way of illustration, specific embodiments in which the disclosure may be practiced. The embodiments are intended to describe aspects of the disclosure in sufficient detail to enable those skilled in the art to practice the invention. Other embodiments may be utilized and changes may be made to the disclosed embodiments without departing from the scope of the disclosure. The following detailed description is not to be taken in a limiting sense, and the scope of the present invention is defined only by the appended claims.

Furthermore, specific implementations shown and described are only examples and should not be construed as the only way to implement the present disclosure unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Also, it is noted that embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer readable media includes both computer storage media and communication media including any medium that facilitates transfer of a computer program from one place to another.

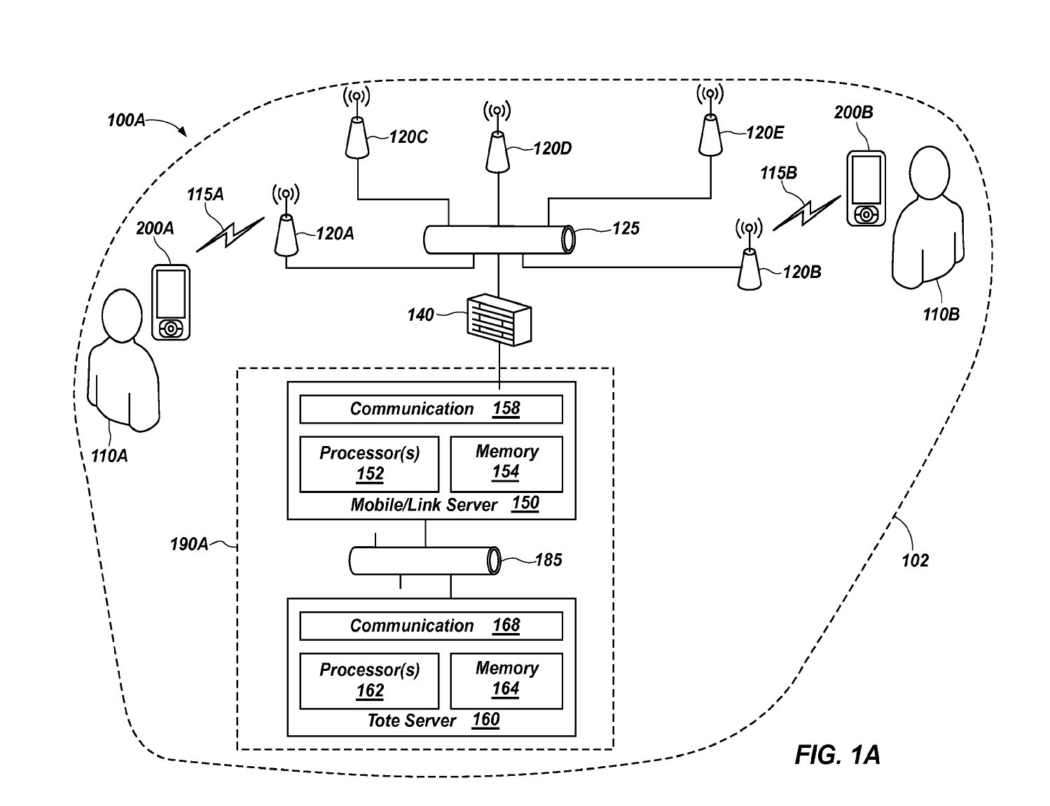

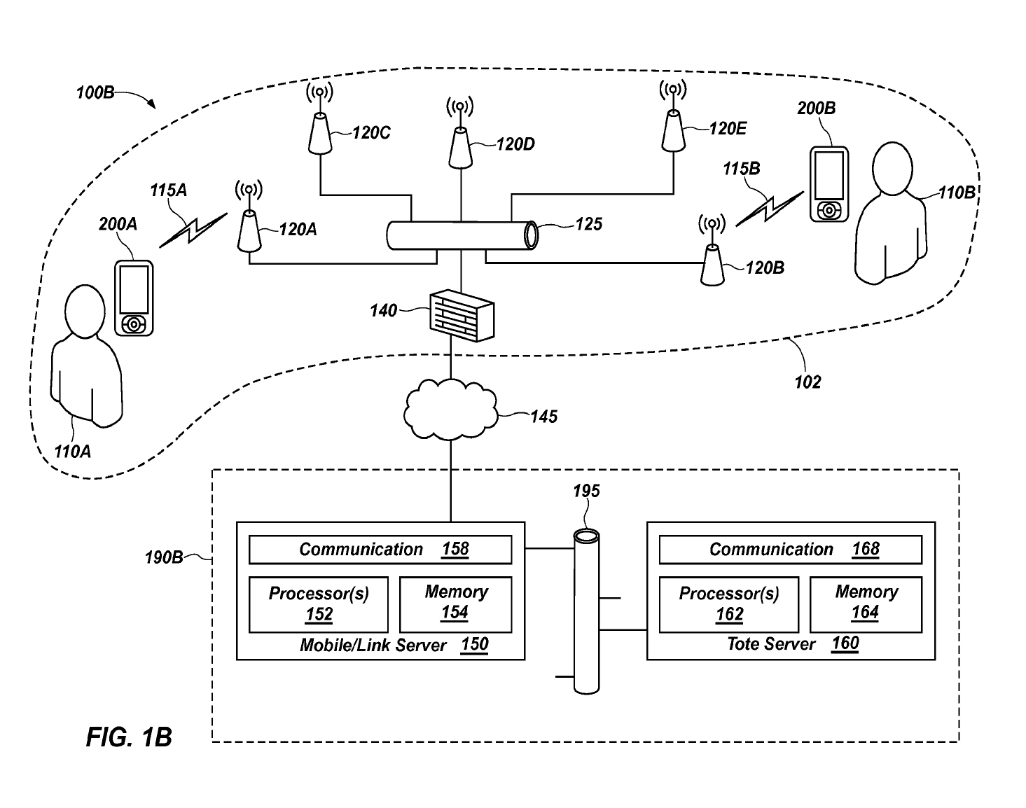

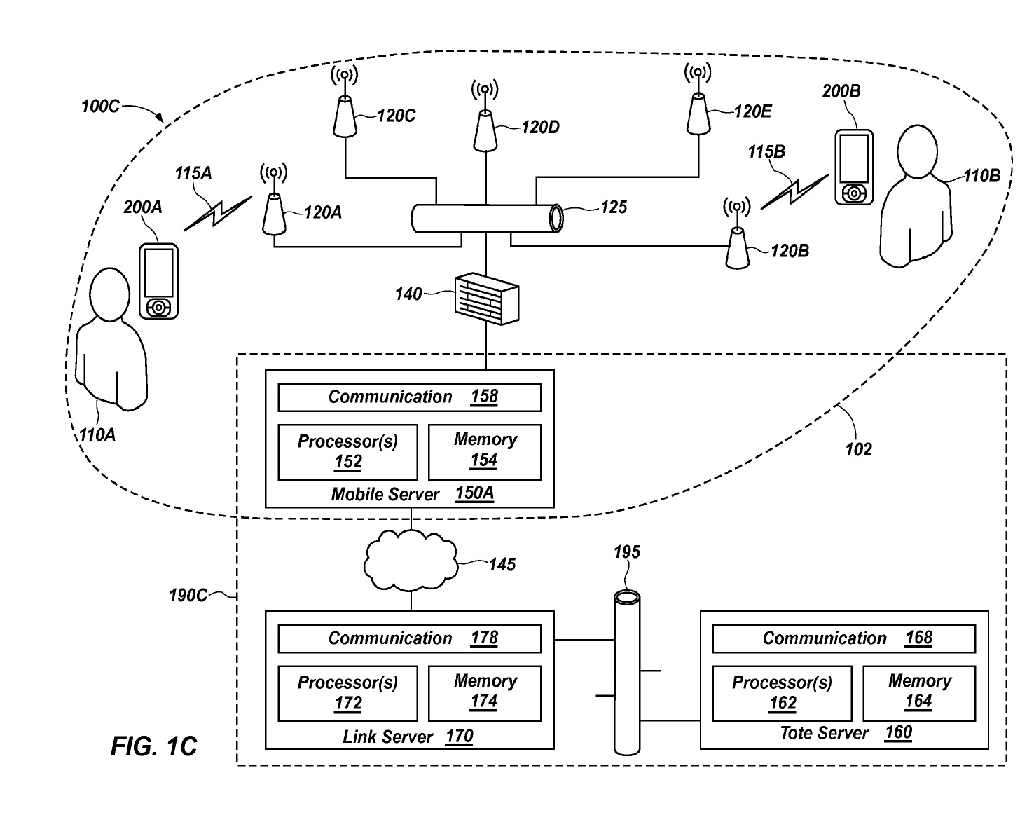

Elements described herein may include multiple instances of the same element. These elements may be generically indicated by a numerical designator (e.g., 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. Thus, for example, element identifiers on a FIG. 1 will be mostly in the numerical format 1xx and elements on a FIG. 4 will be mostly in the numerical format 4xx.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

The term “bus” may be used to refer to a plurality of signals or conductors, which may be used to transfer one or more various types of information, such as data, addresses, control, or status. Additionally, a bus or a collection of signals may be referred to in the singular as a signal. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

Embodiments of the present disclosure include apparatuses, methods, and computer readable that use mobile devices to enable convenient ways for patrons to place wagers at a wagering facility without having to visit a teller or kiosk.

For consistency and ease of description, horse races and horse race tracks are primarily discussed herein. However, embodiments of the present disclosure may be used for other wagering events at other wagering premises, where the wagers may be on other participants such as, for example, dogs, Jai Alai players, and cyclists.

FIGS. 1A-1C are simplified block diagrams of wagering systems 100 using a secure wireless network 125 at a wagering premises 102 to enable wagers to be placed from mobile devices 200A and 200B. The wagering systems 100A, 100B, and 100C differ in communication of wagering information between various servers 150, 160 and 170 in a server system 190. Therefore, the common elements are discussed first, and then differences between wagering systems 100A, 100B, and 100C are discussed.

The secure wireless network 125 enables users 110A and 110B for example, to wirelessly communicate (115A and 115B) with nearby network access points 120A and 120B using wireless communication capabilities in mobile devices 200A and 200B. The access points 120 are coupled to form the secure wireless network 125 for communication with any mobile device 200 that is authorized to be on the secure wireless network 125. The secure wireless network 125 may be configured to cover most, if not all, of the wagering premises 102 such that the users 110 can place wagers from anywhere on the wagering premises 102 where they are in communication range of a network access point 120. Moreover, the secure wireless network 125 may be configured such that the wireless range does not extend significantly beyond the wagering premises 102.

The mobile devices 200 may be any suitable devices that may be carried by a user 110 and are capable of communicating on the secure wireless network 125. As non-limiting examples, the mobile devices 200 may be notebook computers, laptop computers, tablet computers, smart-phones, and similar mobile devices. The mobile devices 200 may utilize a number of operating systems, such as, for example only, Microsoft WINDOWS®, WINDOWS® mobile and other laptop operating systems, ANDROID® operating systems, Apple operating systems, and BLACKBERRY® operating systems.

The secure wireless network 125 may be any suitable wireless communication network capable of handling secure communications such as BLUETOOTH® wireless, 802.11 a/b/g/n type wireless communication, Zigbee, near filed communication and other wireless local area networks and personal area networks.

The mobile devices 200 are configured to perform device executable instructions to carry out the embodiments discussed herein. As non-limiting examples, these device executable instructions may be downloaded over the secure wireless network 125 or may be downloaded over any suitable network through the Internet.

Within the server system 190, a first server 150 communicates with the secure wireless network 125 through a firewall 140. The firewall 140 may be any suitable router or other network device conveying communications on the secure wireless network 125 in a secure fashion.

Each of the servers 150, 160, and 170 respectively include a communication interface 158, 168, 178, memory 154, 164, 174, and one or more processors 152, 162, 168. The servers 150, 160, 170 may be any suitable computer for carrying out operations discussed herein by performing computing instructions and may operate on a variety of operating systems.

In other words, the one or more processors 152, 162, and 172 may be configured for executing computing instructions for a wide variety of operating systems and applications including the computing instructions for carrying out embodiments discussed herein.

The memories 154, 164, 174 may be used to hold computing instructions, data, and other information for performing a wide variety of tasks including performing embodiments of the present disclosure. By way of example, and not limitation, the memories may include Synchronous Random Access Memory (SRAM), Dynamic RAM (DRAM), Read-Only Memory (ROM), Flash memory, and the like.

The communication interfaces 158, 168, 178 may be configured for communicating with other devices or communication networks. By way of example, and not limitation, the communication interfaces 158, 168, 178 may include elements for communicating on wired and wireless communication media, such as, for example, serial ports, parallel ports, Ethernet connections, universal serial bus (USB) connections IEEE 1394 (“firewire”) connections, BLUETOOTH® wireless connections, 802.1 a/b/g/n type wireless connections, and other suitable communication interfaces and protocols.

In the embodiments of FIGS. 1A-1C, the servers 150, 160, and 170 may be configured to perform various processes associated with embodiments of the present disclosure and identified as mobile processes, tote processes, and link processes, respectively. Among other functions, mobile processes may be associated with communications with the mobile devices 200 and supplying the information used for carrying out embodiments of the present disclosure.

Among other functions, tote processes may be associated with approving wagers, collecting information about various wagering events, event participants (e.g., horses, dogs, and Jai Alai players), and wager amounts in order to determine wagering odds for the various event participants in each wagering event. As part of embodiments of the present disclosure, the wagering odds may be communicated to link processes.

Among other functions, link processes may be associated with communicating information used by embodiments of the present disclosure, between the mobile processes and the tote processes. Link processes may also be associated with receiving and forwarding wagers and wager approvals for the various wagering events.

Depending on the configuration, the wireless processes, the link processes, and the tote processes may be performed by different servers or a single server. In the embodiment of FIG. 1A, a mobile/link server 150 (may also be referred to herein as a first server 150) may be configured to perform the mobile processes and the link processes while a tote server 160 (may also be referred to herein as a second server 160) may be configured to perform the tote processes. The mobile/link server 150 communicates through the firewall 140 with the mobile devices 200 through the secure wireless network 125. An on-premises network 185 may be used for communication between the mobile/link server 150 and the tote server 160. In the embodiment of FIG. 1A, the mobile/link server 150, the tote server 160, and the on-premises network 185 are located at the wagering premises 102. In addition, the server system 190 may include a single server 150, wherein the mobile processes and the tote processes are carried out thereon. In such a server system 190, link processes may not be necessary, but could still be included. Moreover, the single server 150 may be located on or off the wagering premises.

The embodiment of FIG. 1B includes a mobile/link server 150 and a tote server 160 as discussed in FIG. 1A. The mobile/link server 150 may communicate with the mobile devices 200 through the secure wireless network 125, through the firewall 140, and through a remote network 145. As non-limiting examples, the remote network 145 may be a Local Area Network (LAN), a Wide Area Network (WAN) or other suitable broad network such as the Internet. Network protocols or structures such as MultiProtocol Label Switching (MPLS) or Virtual Private Networks may be used to create secure connections between the mobile/link server 150 and the secure wireless network 125.

A remote tote network 195 may be used to couple the tote server 160 with the mobile/link server 150. In the embodiment of FIG. 1B, the mobile/link server 150, the tote server 160, and the remote tote network 195 are located remotely from the wagering premises 102. In addition, the tote server 160 may be in a different location than the mobile/link server 150.

In the embodiment of FIG. 1C, the mobile processes and the link processes may be performed by different servers. In the example shown in FIG. 1C, a mobile server 150A is located on the wagering premises 102 and may communicate with the mobile devices 200 through the firewall 140. The mobile server 150A may communicate with a link server 170 (may also be referred to herein as a third server 170) through a remote network 145 such as that discussed above in connection with FIG. 1B. The remote tote network 195 may be used to couple the tote server 160 with the link server 170.

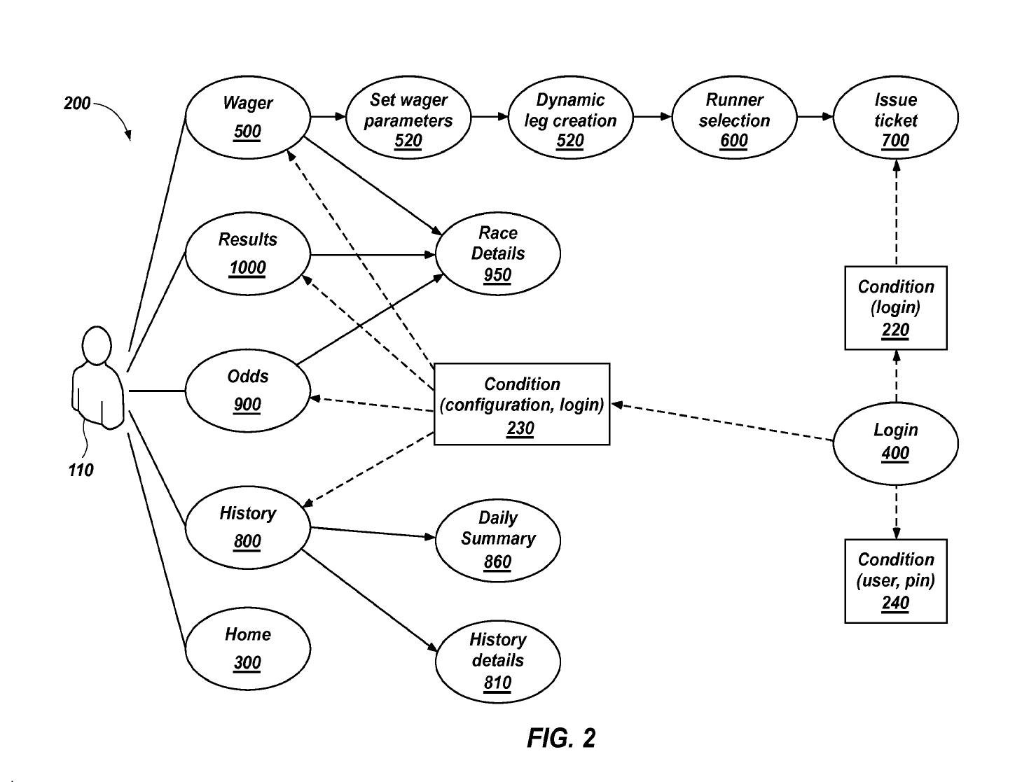

FIG. 2 is a simplified flow diagram of processes performed and interfaces displayed for various activities that can be performed on the mobile devices 200 and are associated with wagering and reviewing events at the wagering premises 102 in accordance with embodiments of the present disclosure. Oval processes generally indicate interfaces that may be presented to the user 110 in the form of a Graphical User Interface (GUI) suitable for viewing by the user 110 and interaction by the user 110 to make certain selections associated with conveying information about a user's account, wagering events, and placing wagers. Square processes generally indicate conditions that may need to be satisfied before the user 110 can access other processes. Each of the interfaces is first introduced while describing FIG. 2 then most interfaces will be discussed in more detail while discussing subsequent figures.

A login interface 300 may be displayed when the user 110 first enters the site associated with embodiment of the present disclosure. Condition 240 indicates that the user 110 has successfully entered a user account identifier and a password before many features of embodiments of the present disclosure may available. As a non-limiting example, condition 220 indicates that the user 110 should be logged in before the user 110 can be issued a ticket through a wager accepted interface 700. As another non-limiting example, condition 230 indicates that the user 110 should be logged in and other configuration conditions met before the user 110 can access interfaces such as a wager interface 500, a results interface 1000, an odds interface 900, and a history interface 800. As non-limiting examples, configuration conditions may be conditions such as having information downloaded to the mobile device 200 related to the wagering premises 102, the wagering events, the event participants, odds associated with the event participants, and information associated with the user's account.

A home interface 400 may be displayed after the user 110 successfully interacts with the login interface 300. From the home interface 400, the user 110 may select other interfaces, such as, for example, the wager interface 500, the results interface 1000, the odds interface 900, and the history interface 800.

From the history interface 800 the user 110 may obtain information about the user's account such as history details 810 and a daily summary 860 as is discussed in more detail below in connection with FIGS. 8A and 8B.

From the wager interface 500 the user 110 may set wager parameters 520. With wager parameters 520 set, the mobile device 200 may dynamically assemble information about a leg (i.e., a wager event). With the information assembled, the user 110 may use a participant interface 600 to select parameters related to the event participants (e.g., runners). After the user 110 successfully selects the necessary parameters for the event participants, the wager accepted interface 700 (e.g., an issue ticket indication) may be displayed to indicate that the wager has been accepted by one or more of the various processes and servers 150, 160, 170 discussed above in connection with FIGS. 1A-1C.

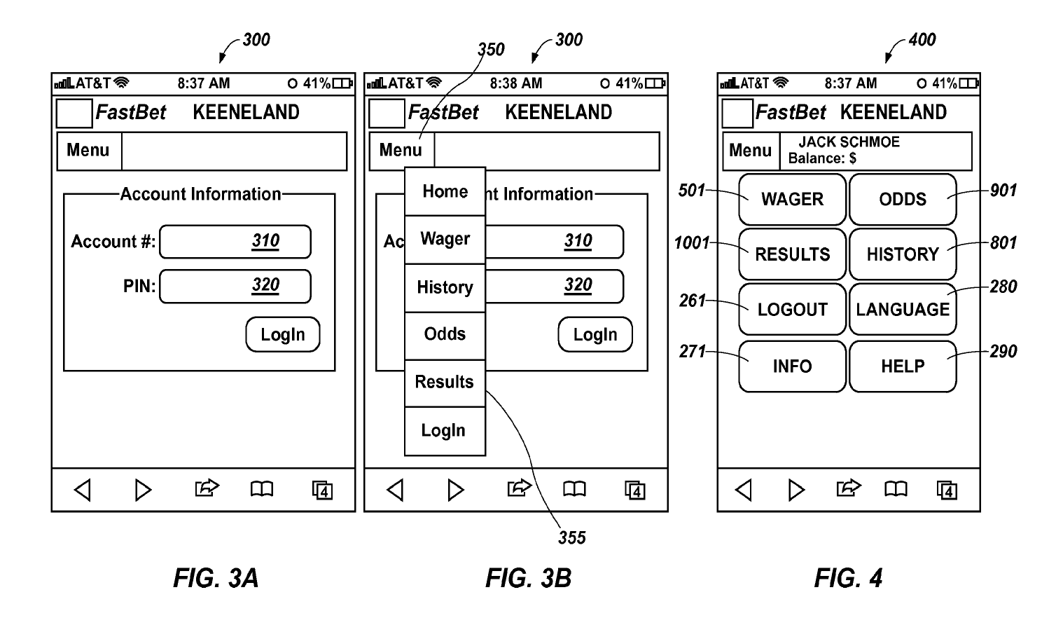

FIGS. 3A and 3B are screen shots of the login interface 300 for the mobile device 200 that may be used in accordance with embodiments of the present disclosure. The login interface 300 enables the user 110 access to the rest of the processes in response to the user 110 providing an account identifier 310 (e.g., an account number) and an account password 320 (e.g., a Personal Identification Number (PIN)). The login interface 300 may authenticate the user 110, generate individual user sessions, and allows the user 110 to review the account details associated with the user 110.

The user's account may be funded through conventional monetary requirements of an Advanced Deposit Wagering (ADW) interface to a pari-mutuel wagering system or other funding system, by visiting a teller or kiosk capable of handling financial transactions for funding the user's account, or other suitable account funding mechanisms. As non-limiting examples, accounts may be funded via methods and apparatuses disclosed in; U.S. Pat. No. 7,749,078, entitled “SYSTEMS AND METHODS FOR ACCESSING, MANIPULATING AND USING FUNDS,” and U.S. patent application Ser. No. 10/731,701, entitled “SYSTEMS AND METHODS FOR ACCESSING, MANIPULATING AND USING FUNDS,” the contents of each of which is hereby incorporated by reference in their entirety.

FIG. 3B also illustrates a menu button 350 (may also be referred to herein as a menu icon 350). Activating the menu button 350 may present a drop down menu list 355 of other interfaces that may be selected. While only discussed in connection with FIG. 3B, the menu button 350 and menu list 355 may be available on many of the various interfaces as will be apparent from the menu button 350 being shown on many of the illustrations of the various interfaces illustrated herein. The menu list 355 enables a convenient way for the user 110 to navigate through features of the embodiments of the present disclosure without having to navigate through the home interface 400.

FIG. 4 is a screen shot of the home interface 400 for the mobile device 200 that may be used in accordance with embodiments of the present disclosure. The home interface 400 may include a wager button 501 for accessing the wager interface 500, an odds button 901 for accessing the odds interface 900, a results button 1001 for accessing the results interface 1000, and a history button 801 for accessing the history interface 800.

A logout button 261 may be included for logging out of a current session of connection to the secure wireless network 125 (FIGS. 1A-1C). A language button 280 may be included for selecting what language should be used for the various user interfaces discussed herein. An information button 271 may be included for presenting information about the system, such as, for example, what kind of browser is being used, what kind of operating system is being used, what kind of mobile device 200 is being used, and what software version is being used. A help button 290 may be included for presenting information, such as, for example, how to use the system and information about what various types of wagers mean.

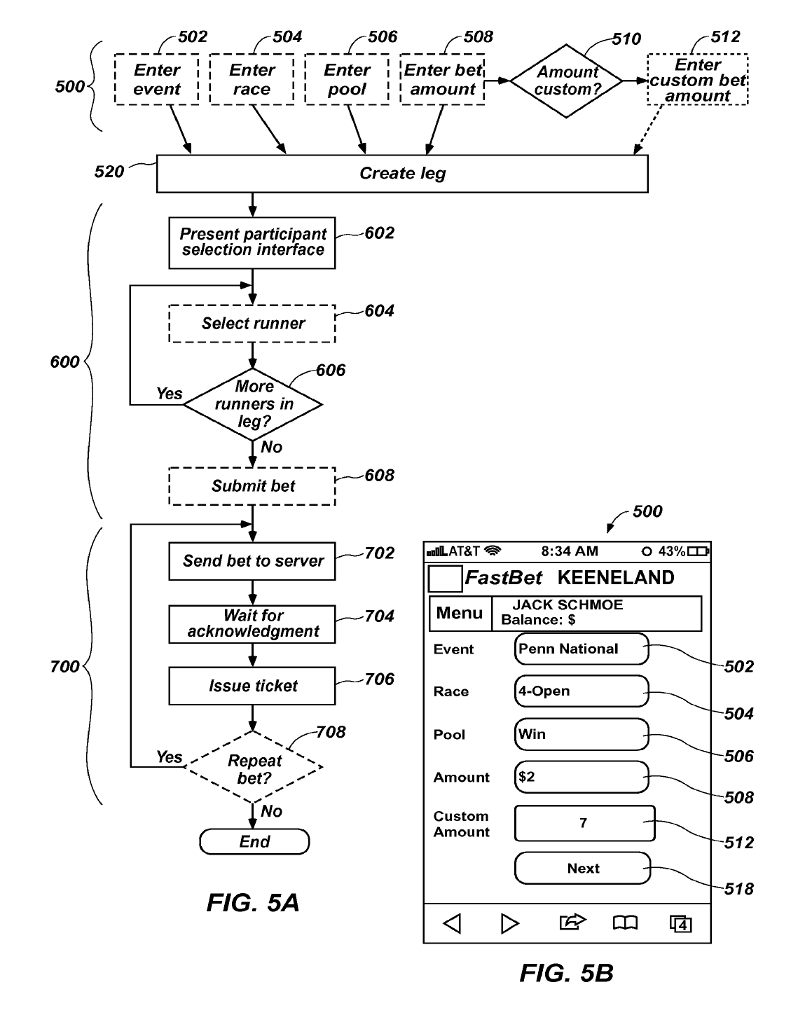

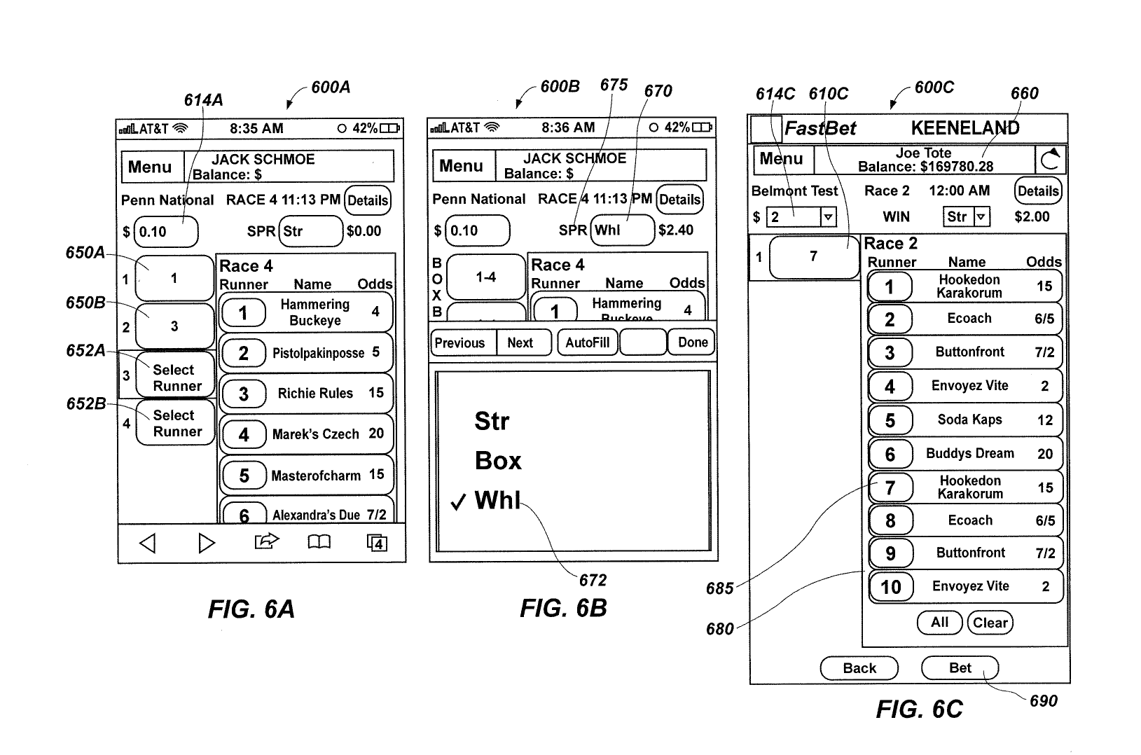

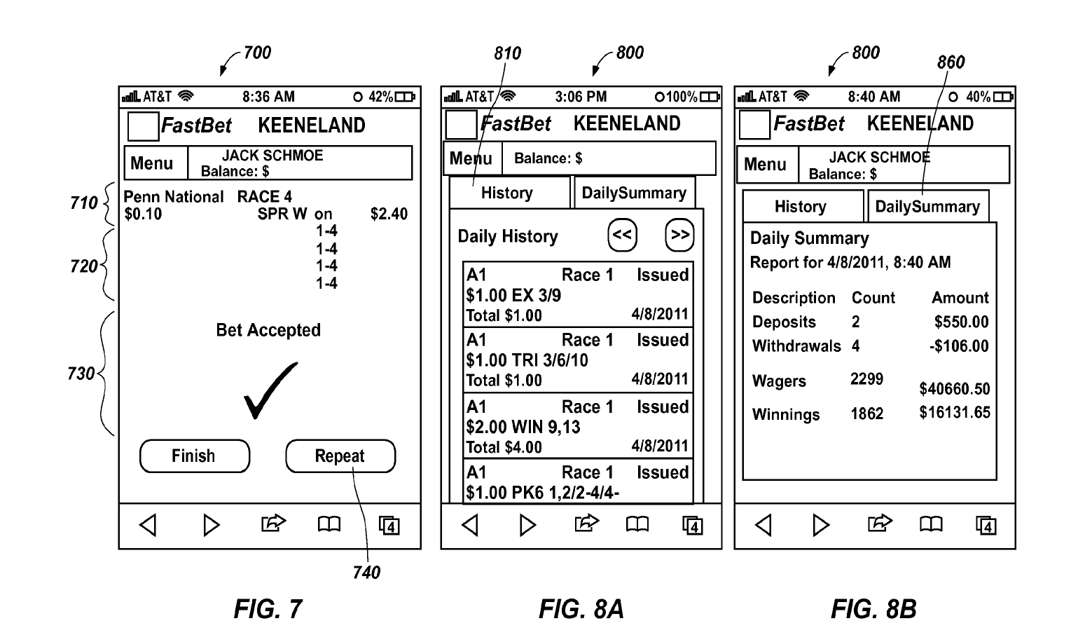

FIG. 5A is a simplified flow diagram of processes performed for various activities involved with reviewing event, assembling wagers, and placing wagers, in accordance with embodiments of the present disclosure. FIG. 5B is a screen shot of the wager interface 500 for the mobile device 200 that may be used for some of the processes illustrated in FIGS. 2 and 5A. FIGS. 6A-6C are screen shots of the participant interface 600 for the mobile device 200 that may be used for some of the processes illustrated in FIGS. 2 and 5A. FIG. 7 is a screen shot of the wager accepted interface 700 for the mobile device 200 that may be used for some of the processes illustrated in FIGS. 2 and 5A.

FIG. 5A is described in connection with the wager interface 500 of FIG. 5B, the participant interface 600 of FIGS. 6A-6C and the wager accepted interface 700 of FIG. 7.

However, it may be worthwhile to present some terms commonly used in pari-mutuel wagering and some common types of wagers that may be placed before discussing further details.

Betting Interests (also referred to herein as Participants and Runners) may be associated with a number that may be selected during the wagering process that corresponds to an object being contested (typically a Horse, Greyhound, Jai Alai player, Cyclist, etc.).

An “Event” may be defined as a collection of races, pools and wagering rules for a current run.

A “Race Card” may be defined as a collection of wagering pools, betting interests and odds for one or more races of an event.

A “Pool” may be defined as a matrix of money and betting interests, which contains how much money is wagered against each available betting interest in a race.

A “Leg” may be defined as a position in a bet of which one or more betting interests may be selected. The number of legs will vary by how many race finish positions are being contested in a wager. In multi-leg pools, the legs may represent different positions in the same race, or positions in multiple races.

Types of wagers that may be placed in horse races and other pari-mutuel wagering events can be quite numerous and sometimes complex. The discussion herein is not meant to be an extensive list of wagers that can be placed using embodiments of the present disclosure. Moreover, embodiments of the present disclosure may be adapted to new types of wagers that may be defined in the future as wager popularity, user's tastes, and marketing promotions for wagering premises may change.

Straight bets may be simple wagers such as, Win (choosing a betting interest to come in first), Place (choosing a betting interest to come in first, or second) and Show (choosing a betting interest to come in first, second, or third). More complex wagers are often called exotic bets and include some of the following types of bets.

Combine Pools (WPS, WET, WP, PS, WS)—A combination of wagering pools that are wagered at the same time. For example, when wagering a WPS the patron wagers a Win, Place and Show wager at the same time. Wagering a WET allows the patron to wager a Win, Exacta and Trifecta at the same time.

Exacta (Perfecta, Exactor)—A wager involving choosing the betting interests to finish first and second in exact order in one race.

Quinella—A wager involving choosing the betting interests to finish first and second in either order in one race.

Trifecta (Triactor)—A wager involving choosing the betting interests to finish first, second, and third in exact order in one race.

Superfecta—A wager involving choosing the betting interests to finish first, second, third, and fourth in exact order in one race.

PentaFecta—A wager involving choosing the betting interests to finish first, second, third, fourth and fifth in exact order in one race.

Hexafecta—A wager involving choosing the betting interests to finish first, second, third, fourth, fifth and sixth in exact order in one race.

Double (Daily Double)—A wager involving choosing the betting interests to finish first in each of two designated races included in the Daily Double.

Triple (Pick 3)—A wager involving choosing the betting interests to finish first in each of three designated races included in the Triple.

Pick N (Pick 4, Pick 5, Pick 6, etc.)—A wager involving choosing “N” number of races and choosing the betting interests to finish first in each of the designated races included in the Pick N.

Grand Slam—A wager involving four races. The patron chooses the betting interests to finish first in three races and the betting interest that comes in first, second or third in the fourth race.

Quinella Double—A wager involving two Quinella wagers, each placed on an independent race.

Triella—A wager like a Quinella, except instead of choosing the winning betting interests for two positions, the patron chooses three positions.

Over/Under—A proposition style wager in which a value is determined by the quantity of runners in the race and the patron must wager that the sum of the runner numbers to finish the race in the First, Second, Third and Fourth positions will be over, under or on the predetermined value.

Exchange Wagering—An exchange wagers is a bet wherein a percentage of the first bet (usually 50%) is placed in a pool to be applied to the second bet. Upon winning the first leg, a bettor must take his ticket to a window and cash his winning ticket and then place, (with no additional cost) at a value equal to his original bet, the wager for the next leg in the race. The bettor must hit each half of the wager to hit the jackpot. In embodiments of the present disclosure, there would be no need for the user 110 to go to a ticket window.

Twin-Trifecta—A wager involving an exchange wager with two trifectas.

Tri-Super—An exchange wager with two parts. The first part of the Tri Super is a trifecta (exact order of 1st-2nd-3rd). The second part of the Tri-Super is a Superfecta (pick first 4 finishers exact order of 1 st-2nd-3rd-4th)

Big Quinella—A wager involving choosing the runners to finish first and second in either order for two designated races with an exchange to the second race.

Beyond these various wagers, a wager may involve qualifying the bet with combinations other than a straight bet, such as, for example, Box and Wheel combinations. These combination are discussed below in connection with FIG. 6B.

Returning to FIGS. 5A and 5B, a user 110 may begin placing a wager by interacting with the wager interface 500. Processes in FIG. 5A illustrated as dashed lines are entries the user 110 performs to formulate a wager. Processes illustrated with a solid line are processes performed by device executable instructions or server executable instructions on the mobile device 200 or one of the servers 150, 160, 170, respectively. Processes illustrated with a dotted line are entries the user 110 may conditionally perform as a result of other entries.

In the user interfaces discussed herein, reference will generally be made to dropdown lists that may be presented when a button or icon on an interface is selected. However, embodiments of the present disclosure may also use popup windows, jump to other windows, or use other graphical elements to present selectable options or entry boxes to the user 110.

In the wager interface 500, the user 110 selects an event from the event button 502, which may present a dropdown list of possible events to choose from. The user 110 selects a race from the race button 504, which may present a dropdown list of possible races to choose from, which may be based on the event selected. A combination of the selected event and the selected race may be referred to herein as a wager identification.

The user 110 selects a pool from the pool button 506, which may present a dropdown list of possible types of wagers that may be placed, such as, for example, win, place, show, trifecta, etc. The elements in the dropdown list for the pool button 506 may be based on the event selected and the race selected. The selected pool may also be referred to herein as a wager type.

The user 110 may define a base wager by selecting an amount button 508, which may present a list of possible base wager amounts. In some embodiments a custom amount entry box 512 may be included, in which case an entry in the custom amount entry box 512 would override the amount selected by the amount button 508. In other embodiments, the amount button may include “custom” as an option to select in the dropdown list. If “custom” is selected, then decision block 510 indicates that the custom amount entry box 512 may be displayed for enabling the user 110 to enter a custom amount that is different from the list of amounts that can be selected from the dropdown list.

When a valid wager identification, wager type, and wager amount have been defined by having valid entries selected for all of buttons 502, 504, 506, and either button 508 or entry box 512, the user 110 may select a next button 518. When the next button 518 is selected, operation block 520 indicates that a leg is dynamically created based on the entries on the wager interface 500, and options and information related to the dynamically created leg are shown on the participant interface 600 as illustrated in FIGS. 6A-6C and portions of FIG. 5A encompassed by the brace labeled 600.

In the participant interface 600, an amount button 614A and 614C (may also be referred to herein as a wager indicator 614) shows the base wager amount and in some embodiments may be selectable to present a dropdown list or other form for modifying the base wager amount. It should be noted that FIG. 6C illustrates a somewhat different interface from a different browser implementation to illustrate that embodiments of the present disclosure may show various elements in a slightly different fashion.

A user indicator 660 may be presented on the participant interface 600, as well as many other user interfaces. The user indicator 660 may present information such as, for example, the user's name and a current balance in the user's account.

Identifier 675 indicates the wager type. In FIGS. 6A and 6B, the wager type is a superfecta abbreviated as “SPR.” Combination button 670 may be selected by the user 110 to present a dropdown list 672 to modify the type of wager. The wager combination may default to a straight bet. However, the user 110 may modify the straight bet to other combinations, such as, for example, a box or a wheel combination.

As an example with a trifecta type wager, a trifecta “box” with a selection of horses 1-4-7 would pay off if the first three finishers in the race were 1, 4, and 7 in any order. As an example of the trifecta “wheel” type wager, a user 110 selects one or more key horses in various positions relative to other combinations of horses. For example, a trifecta wheel might key horse 2 to win with horses 3, 5, and 7 to finish second and horses 1, 4, and 6 to finish third. This wager would pay off if horse 2 won, any of horses 3, 5, and 7 finished second, and any of horses 1, 4, and 6 finished third.

An event participant column 680 on the right of the participant interface 600 indicates the race number and lists the participants 685 in the race. As a non-limiting example, the event participant column may include information such as the participant's number, name, and odds of winning the event.

A participant selector column on the left of the participant interface 600 includes buttons (e.g., 650A, 650B, 652A, 652B, and 610C) for the user 110 to select to identify the participant that he wants to finish in that position. The indication of which participants are selected for which participant button may be referred to herein as a participant goal. The number of buttons that are presented in the participant selector column will depend on the wager type. For example, in FIG. 6C the wager type is to win so only a single participant needs to be selected. Button 610C indicates that participant number 7 has been selected and participant 7 may be highlighted in the participant information column. As another example, in FIG. 6A the wager type is a superfecta, so four participant selection buttons will be shown. Buttons 650A and 650B indicate that participant numbers 1 and 3 have been respectively selected for those positions. Buttons 652A and 652B may show an identifier, such as, for example, “select runner” to indicate that participants for those positions have not yet been selected. Of course other indicators may be used. As non-limiting examples, buttons 650A, 650B, and 610C may show the participant number, the participant name, the participant odds, or combinations thereof. Buttons 652A and 652B may be shown in a different color or have other text identifying that a participant needs to be selected for that button.

The participant selector column for FIG. 6B also illustrates that the wager is set as a “box” wager and the first participant selection buttons indicates “1-4” as the participants selected for that position. However, the user 110 has selected the combination button 670, which presents the dropdown list 672 and the user 110 has changed the wager type to “wheel.” When the dropdown list is closed, the participant selector column may change to indicate a wheel type wager. In addition, if appropriate, the number of participant buttons may change and any previous participant selections made by the user 110 may reset if they are no longer meaningful for the new wager type. A combination of selected participants may be referred to herein as a participant identification and the selected finish positions related to the wager type may be referred to herein as participant goals.

When all the participants have been properly selected, the user 110 may select a “bet” button 690 to make a wager request to process the bet. In addition, at any time the user 110 may press a back button to return to the wager interface 500 to change other parameters of the wager that may not be available on the participant interface 600.

Returning to FIG. 5A in combination with FIGS. 6A-6C, the participant selection process may begin with operation block 602 to present the participant interface 600. Operation block 604 indicates that the user 110 may then select a runner as described above. Decision block 606 indicates that the process may loop back to operation block 604 to allow the user 110 to select more runners if they have not all been selected, modify selections for runners that have already been selected, modify the base wager amount, or modify the wager type.

When all the runners have been selected for the current wager type, operation block 608 indicates that the user 110 may select the bet button 690 to submit the bet for processing.

Operations within bracket 700 in FIG. 5A and the wager accepted interface 700 in FIG. 7 illustrate a process for accepting the wager and notifying the user 110 of the acceptance.

Referring to FIGS. 1A-1C, 5A and 7, operation block 702 indicates that the mobile device 200 sends the wager to the server 150. Operation block 704 indicates that the mobile device 200 waits for a wager acknowledgment to return from one of the servers in the server system 190, via the server 150. Operation block 706 indicates that a ticket is issued, which may be a “virtual” ticket in that it is presented on the user interface of the mobile device 200 and not printed out as a physical ticket. The presentation of the virtual ticket is illustrated in the wager accepted interface 700.

In the wager accepted interface 700, region 710 may display the wager identification information, such as, for example, base wager amount, wagering premises, event (e.g., race), and wager type. Region 720 may illustrate the participant goals, which identify the participant and its goal finish position(s) depending on the wager type. Region 730 may give a wager acknowledgement in the form of an acknowledgement indicator comprising text, icon, audio, or other type of indication to indicate that the wager has been accepted.

Decision block 708 and repeat button 740 indicate that the wager may be placed again simply by selecting the repeat button 740 and the overall wager acceptance process is repeated.

FIGS. 8A and 8B are screen shots of the history interface 800 for the mobile device 200 that may be used for some of the processes illustrated in FIG. 2. FIG. 8A illustrates that the history tab 810 (may also be referred to herein as a wager history interface 810) has been selected to display the history of transactions for the user's account for a predetermined number of transactions, such as, for example, the past 20 transactions. As non-limiting examples, the history tab 810 may display the past 20 wagers placed and the status of those wagers such as whether the wagers have been issued or canceled. In addition, different colors, or other indicators, may be used to indicate different status, such as, for example, green may be used to indicate a winning ticket, red may be used to indicate a cancelled ticket, and yellow may be used to indicate a pending ticket. In some embodiments, the user 110 may be able to select and cancel pending tickets. As non-limiting examples, the history tab 810 may present information such as race, wager type, amount won, etc.

FIG. 8B illustrates that the summary tab 860 (may also be referred to herein as an account summary interface 860) has been selected to display a summary of the user's account for a predetermined time period, such as, for example, a daily summary. As non-limiting examples, the summary tab 860 may display information such as deposits, withdrawals, wagers, winnings, etc., associated with the user's account.

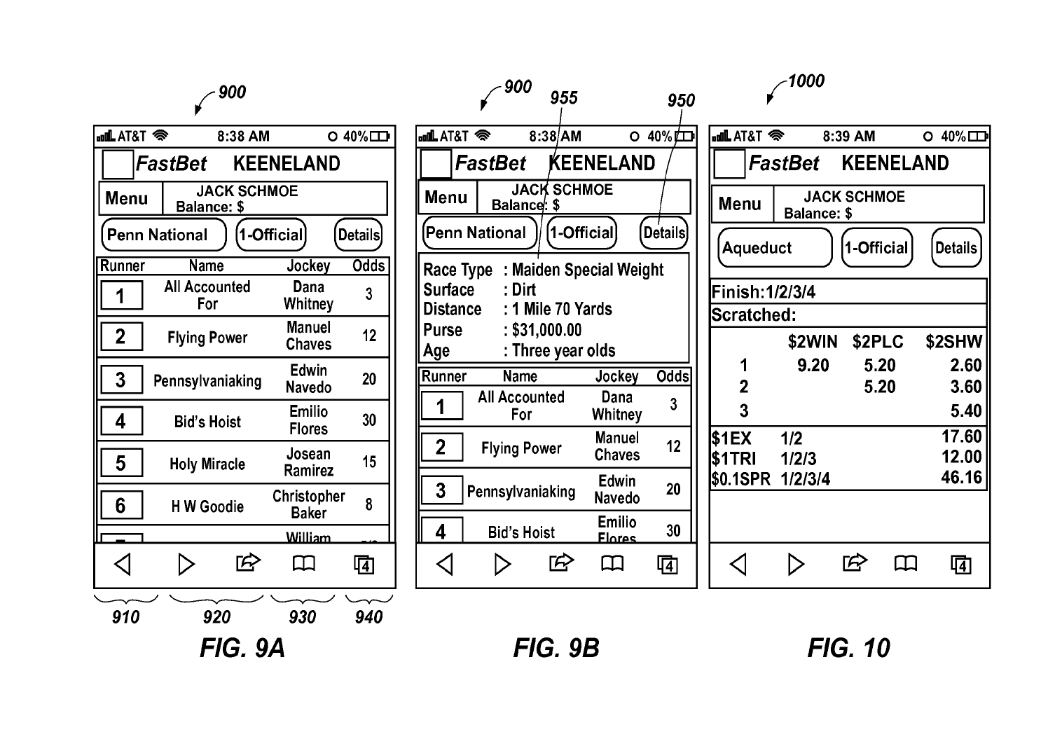

FIGS. 9A and 9B are screen shots of the odds interface 900 for the mobile device 200 that may be used in accordance with embodiments of the present disclosure. The user 110 may be able to select an event to retrieve the current odds for all the races in the event. Region 910 indicates that the participant's number may be displayed for each participant in the event. Region 920 indicates that the participant's names may be displayed. Region 930 indicates that the jockey riding the participant may be displayed. Region 940 indicates that the odds for each participant are displayed. Other information, such as, for example, a participant's past history or a jockey's past history may also be displayed within the odds interface 900 or upon selection of a participant.

FIG. 9B illustrates that a “details” button 950 (also referred to herein as an event details icon 950) has been selected by the user 110, which causes additional event information 955 to be presented. While discussed with reference to FIG. 9B, the event details icon 950 may be presented and operational on many other user interfaces for embodiments of the present disclosure.

FIG. 10 is a screen shot of the results interface 1000 for the mobile device 200 that may be used in accordance with embodiments of the present disclosure. The results interface 1000 may enable the user 110 to select a wagering premises and a completed event to show information about how the participants finished in the event, as well as other information such as related pool totals, finishers, and scratches. Participants shown on the results interface 1000 may be referred to herein as result participants.

While the disclosure is susceptible to various modifications and implementation in alternative forms, specific embodiments have been shown by way of examples in the drawings and have been described in detail herein. However, it should be understood that the invention is not intended to be limited to the particular forms disclosed. Rather, the invention includes all modifications, equivalents, and alternatives falling within the scope of the following appended claims and their legal equivalents.

1. A wagering system, comprising:
a secure wireless network configured for operation within a wagering premises and comprising one or more network access points for transmitting and receiving network data for devices authorized to participate on the secure wireless network; and
a server system comprising one or more servers, wherein a first server is configured for communicating with the secure wireless network;
the first server comprising:
a communication interface configured for conveying wager requests and wager acknowledgements on the secure wireless network and between the first server and one or more mobile devices configured for sending the wager requests and receiving the wager acknowledgements;
memory configured for storing server executable instructions; and
one or more processors configured for executing the server executable instructions to:
send authorization to the one or more mobile devices to participate on the secure wireless network;
receive the wager requests from the one or more mobile devices communicating over the secure wireless network; and
send the wager acknowledgements to the one or more mobile devices communicating over the secure wireless network.

2. The wagering system of claim 1, wherein the one or more servers include a second server, comprising:
a second communication interface;
a second memory configured for storing second server executable instructions; and
a second processer configured for executing the second server executable instructions to:
receive the wager requests from the first server;
totalize wager amounts for each wagering event from each of the one or more portable devices and other wager amounts for each of the wagering events from other sources;
develop wagering odds associated with each of one or more participants for each of the wagering events; and
communicate the wagering odds to the first server.

3. The wagering system of claim 2, wherein the first server and the second server are located on the wagering premises.

4. The wagering system of claim 2, wherein the first server is located on the wagering premises and the second server is located off the wagering premises.

5. The wagering system of claim 2, wherein the first server and the second server are located off the wagering premises.

6. The wagering system of claim 2, wherein the one or more processors of the second server are further configured for executing the server executable instructions to process and approve the wager requests to develop the wager acknowledgements.

7. The wagering system of claim 2, wherein the one or more servers include a third server, comprising:
a third communication interface;
a second memory configured for storing third server executable instructions; and
a second processor configured for executing the third server executable instructions to:
receive the wager requests from the first server and send them to the second server; and
receive the wager acknowledgements from the second server and send them to the first server.

8. A wagering system, comprising:
a secure wireless network configured for operation within a wagering premises and comprising one or more network access points for transmitting and receiving network data for devices authorized to participate on the secure wireless network; and
the server configured for communicating with the secure wireless network and comprising:
a communication interface configured for conveying wager requests and wager acknowledgements on the secure wireless network and between the first server and one or more mobile devices configured for sending the wager requests and receiving the wager acknowledgements;
memory configured for storing server executable instructions; and
one or more processors configured for executing the server executable instructions to:
send authorization to the one or more mobile devices to participate on the secure wireless network;
receive the wager requests from the one or more mobile devices communicating over the secure wireless network after the one or more mobile devices have been authorized to participate on the secure wireless network; and
send the wager acknowledgements to the one or more mobile devices communicating over the secure wireless network after the one or more mobile devices have been authorized to participate on the secure wireless network.

9. The wagering system of claim 8, wherein the one or more processors are further configured for executing the server executable instructions to process and approve the wager requests to develop the wager acknowledgements.

10. The wagering system of claim 8, wherein the one or more processors are further configured for executing the server executable instructions to:
totalize wager amounts for each wagering event from each of the one or more mobile devices and other wager amounts for each of the wagering events from other sources;
develop wagering odds associated with each of one or more participants for each of the wagering events; and
communicate the wagering odds to the one or more mobile devices.

11. A wagering method, comprising:
providing a secure wireless network configured for operation substantially within a physical confines of a wagering premises and comprising one or more network access points for transmitting and receiving network data for devices authorized to participate on the secure wireless network;
receiving a request to participate on the secure wireless network from one or more mobile devices;
sending authorization to participate on the secure wireless network over the secure wireless network to the one or more mobile devices;
receiving wager requests from the one or more mobile devices communicating over the secure wireless network after the one or more mobile devices have been authorized to participate on the secure wireless network; and
sending wager acknowledgements to the one or more mobile devices communicating over the secure wireless network after the one or more mobile devices have been authorized to participate on the secure wireless network.

12. The wagering system of claim 11, further comprising processing and approving the wager requests to develop the wager acknowledgements.

13. The wagering system of claim 11, further comprising:
totalizing wager amounts for each wagering event from each of the one or more mobile devices and other wager amounts for each of the wagering events from other sources;
developing wagering odds associated with each of one or more participants for each of the wagering events; and
communicating the wagering odds to the one or more mobile devices.

14. Computer-readable media including device executable instructions, which when executed by a server cause the server to:
receive a request to participate on a secure wireless network from one or more mobile devices, the secure wireless network configured for operation substantially within a physical confines of a wagering premises and comprising one or more network access points for transmitting and receiving network data for devices authorized to participate on the secure wireless network;
send authorization to participate on the secure wireless network over the secure wireless network to the one or more mobile devices;
receive wager requests from the one or more mobile devices communicating over the secure wireless network after the one or more mobile devices have been authorized to participate on the secure wireless network; and
send wager acknowledgements to the one or more mobile devices communicating over the secure wireless network after the one or more mobile devices have been authorized to participate on the secure wireless network.

15. The computer-readable media of claim 14, including device executable instructions, which when executed by the server further cause the server to process and approve the wager requests to develop the wager acknowledgements.

16. The computer-readable media of claim 14, including device executable instructions, which when executed by the server further cause the server to:
totalize wager amounts for each wagering event from each of the one or more mobile devices and other wager amounts for each of the wagering events from other sources;
develop wagering odds associated with each of one or more participants for each of the wagering events; and
communicate the wagering odds to the one or more mobile devices.
